(19) United States
(12) Patent Application Publication
(10) Pub. No.: US 2015/0148039 A1
(43) Pub. Date: May 28, 2015

(54) WIRELESS COMMUNICATION OPTIMIZED MULTIPLE FREQUENCY MEASUREMENT SCHEDULE

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/087,998

(22) Filed: Nov. 22, 2013

(51) Int. Cl. H04W 36/00

(52) U.S. Cl. CPC H04W 36/0083
USPC 455/436

(57) ABSTRACT

An optimized strategy for preparing measurement reports in a telecommunication system separates searching and measuring of candidate frequencies for device handover, searching a series of frequencies and then determining which frequencies to measure based on the search results. The search results may be sorted, prioritizing the order measurements are undertaken. Preliminary results may be used to determine that a frequency is a poor handover candidate, advancing to the next frequency.

### BACKGROUND

1. Field

Aspects of the present disclosure relate generally to wireless communication systems, and more particularly, to performing measurements of multiple potential neighbor frequencies based on information provided by a serving network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method for wireless communication. The method includes receiving an indication of potential neighboring frequencies from a serving network. The method also includes sequentially searching a plurality of the potential neighboring frequencies prior to performing measurements on any of the searched potential neighboring frequencies. The method further includes measuring one or more of the plurality of the potential neighboring frequencies. The measuring may be based at least in part on results of the searching.

Also offered is an apparatus for wireless communication. The apparatus includes means for receiving an indication of potential neighboring frequencies from a serving network. The apparatus further includes means for sequentially searching a plurality of the potential neighboring frequencies prior to performing measurements on any of the searched potential neighboring frequencies. The apparatus also includes means for measuring one or more of the plurality of the potential neighboring frequencies. The measuring may be based at least in part on results of the search performed by the means for sequentially searching.

Also offered is a computer program product for wireless communication in a wireless network. The computer program product includes a non-transitory computer-readable medium having program code recorded thereon. The program code also includes program code to sequentially search a plurality of potential neighboring frequencies received from a serving network prior to performing measurements on any of the searched potential neighboring frequencies. The program code further includes program code to measure one or more of the plurality of the potential neighboring frequencies. The measuring may be based at least in part on results of the searching.

Also offered is an apparatus for wireless communication. The apparatus includes a memory and at least one processor coupled to the memory. The processor(s) are configured to receive an indication of potential neighboring frequencies from a serving network. The processor(s) are also configured to sequentially search a plurality of the potential neighboring frequencies prior to performing measurements on any of the searched potential neighboring frequencies. The processor(s) are further configured to measure one or more of the plurality of the potential neighboring frequencies. The measuring may be based at least in part on results of the sequential search.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas.

FIGS. 5A to 5E illustrate a conventional and improved sequences for conducting searches and measurements across multiple frequencies.

FIG. 6 is a communication flow diagram based on the improved search and measurement sequence illustrated in FIG. 5C.

FIG. 7 is a block diagram illustrating an improved method for conducting search and measurement across multiple frequencies.

FIG. 8 is a diagram illustrating an example of a hardware implementation for an apparatus employing the improved method for conducting search and measurement across multiple frequencies.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

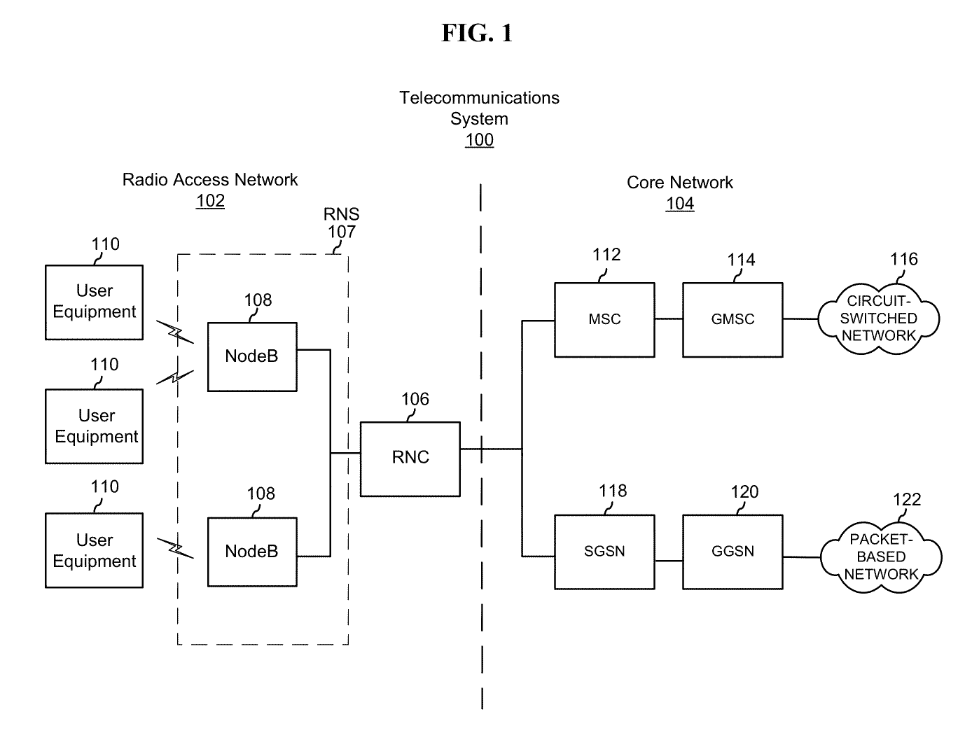

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

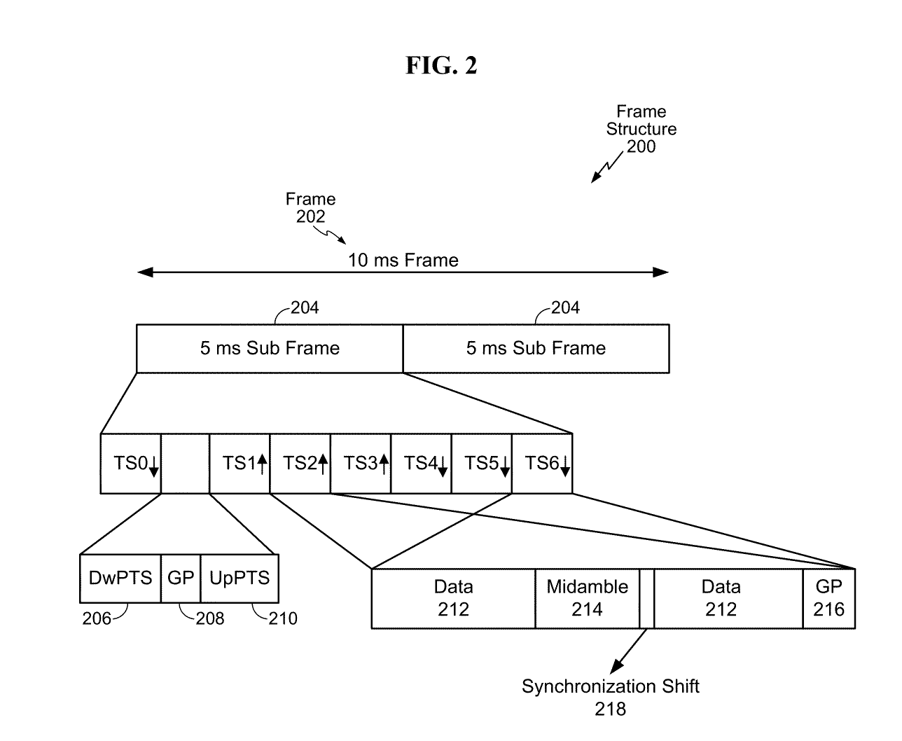

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps (Mega chips per second). The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

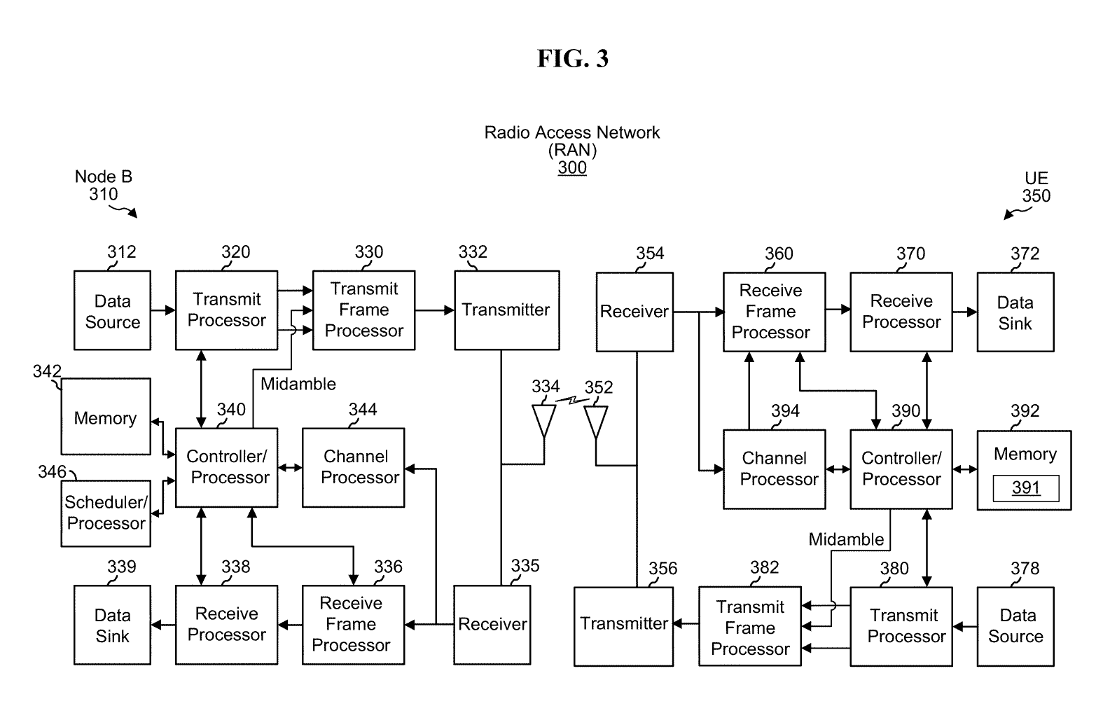

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and de-spreads the symbols, and then determines the most likely signal constellation points transmitted by the node B 310 based on the modulation scheme. These soft decisions may be based on channel estimates computed by the channel processor 394. The soft decisions are then decoded and de-interleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. Non-transitory computer readable media aspects of memories 342 and 392 may store data and software for the node B 310 and the UE 350, respectively. For example, a portion 391 of the memory 392 of the UE 350 may store code comprising a search module 802, a measurement module 804, and an optimization module 806 which, when executed by the controller/processor 390, configure the UE 350 for optimized measurement of multiple potential neighbor frequencies. A scheduler/processor 346 at the node B 310 may be used to allocate resources to the UEs and schedule downlink and/or uplink transmissions for the UEs.

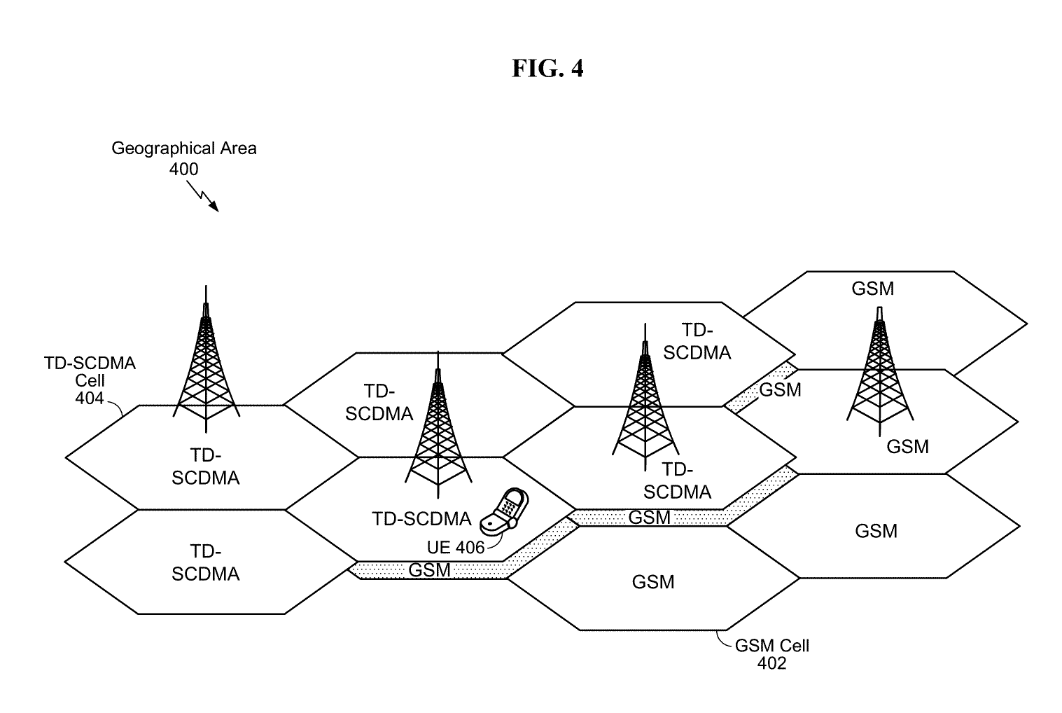

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. An “event 3A” may be triggered when the estimated quality of the currently used UTRAN frequency is below a certain threshold and the estimated quality of another system is above a certain threshold. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC of the second RAT and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of the broadcast control channel (BCCH) carrier, identifies the BSIC, at least one time, with an initial BSIC identification and reconfirms. The initial BSIC identification is performed within a predefined time period (for example, Tidentify_abort=5 seconds). The BSIC is re-confirmed at least once every Tre-confirm abort_seconds (e.g., Tre-confirm_abort=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

### Optimized Multiple Frequency Measurement

TD-SCDMA is based on the time division and code division to allow multiple UEs to share the same radio bandwidth on a particular frequency channel. The bandwidth of each frequency channel in TD-SCDMA system is 1.6 MHz, operating at 1.28 Mcps. The downlink and uplink transmissions share the same bandwidth in different time slots (TSs). In each time slot, there are multiple code channels. Certain time slots may be configured for uplink communications while others are configured for downlink communications. For example, referring back to the frame structure in FIG. 2, there is one downlink (DL) time slot TS0, followed by three uplink (UL) timeslots TS1-TS3, and followed by three DL timeslots TS4-TS6. Between TS0 and TS1, there are a Downlink Pilot Time Slot (DwPTS 206) and an Uplink Pilot Time Slot (UpPTS 210), separated by a “gap” (guard period 208). The Downlink Pilot Time Slot 206 is used to transmit a Downlink Pilot Channel (DwPCH).

When camped or connected on a serving cell, a UE may receive a cell information list comprising multiple neighboring frequencies with the same priority in the serving TD-SCDMA radio access technology (RAT) and/or be informed of neighbor frequencies of others RATs, such as GSM, LTE, etc. The serving cell may request that the UE prepare and reply with a measurement report for these neighbor frequencies. The neighboring frequencies may serve as handover candidates, with the network potentially directing the UE to transfer to one of the neighboring frequencies based upon the measurements in the measurement report. To prepare the report the UE performs a series of search and measurement operations. Each search and measurement operation of neighboring frequencies may comprise a series of steps and procedures.

For example, “Search” may include detection of a gap, detection of downlink sync sequences, and detection of midambles. Detection of the gap (GP 208) of a frame of the candidate frequency provides BSIC identification, and the UE may sample the power profile of the sync channel. Detection of the downlink sync sequence of a frame on the candidate frequency is performed during the candidate frequency's Downlink Pilot Time Slot (DwPTS 206). The UE may detect the “number” of sync sequences and determine the sync sequence signal-to-interference-plus-noise ratio (SINR) or signal to noise ratio (SNR). The UE may also detects a “number” of midambles (214 in FIG. 2) of one or more timeslots on the candidate frequency and may determine the SINR/SNR of the detected midambles. The number of midambles detected provides an indication of interference on the candidate frequency, and is related to signal strength and quality. For example, for a specific frequency, TD-SCDMA includes thirty-two sync sequences and one-hundred-twenty-eight midambles. To determine the “number” of sync sequences and midambles, the UE may do correlation (one-by-one) to check how many downlink (DL) sync sequences and midambles are above a preset threshold.

“Measurement” may include a wide variety of tests, such as measuring the Downlink Pilot Channel (DwPCH) or a reference signal (e.g., a sync channel, the received signal code power (RSCP) or received signal strength indicator (RSSI) of the broadcast control channel (BCCH), etc.) of the candidate frequency.

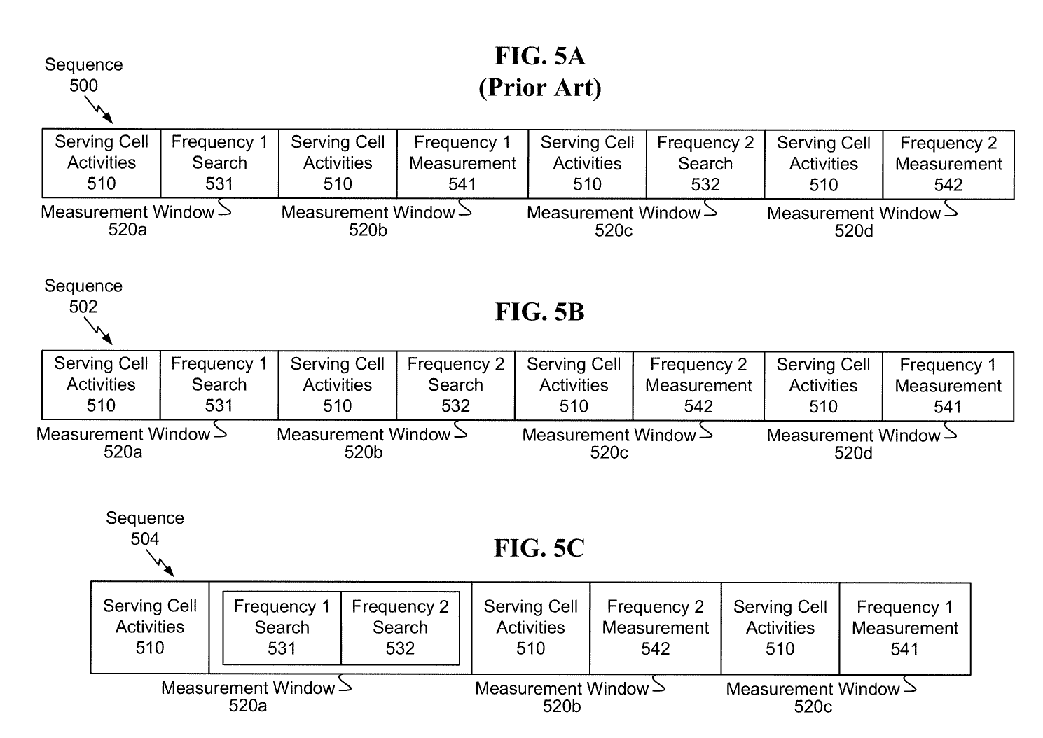

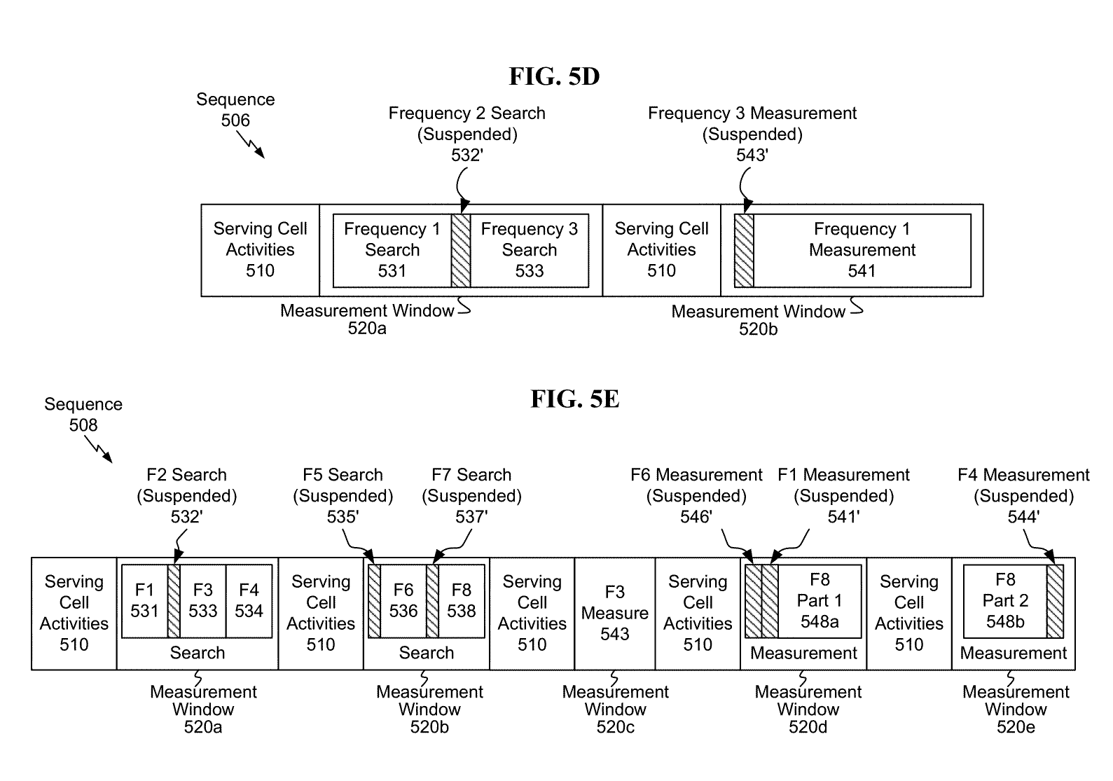

In conventional systems, as illustrated by the search and measurement sequence 500 in FIG. 5A, the measurement schedule calls for the UE to perform measurement activities for the neighboring frequencies in a round-robin way due to the short measurement time windows 520 available to the UE between communication activities 510 with the serving cell. The UE first performs a search (531) or acquisition on a sync channel for a first neighbor frequency during a first measurement window 520a, and then performs a measurement (541) on the DwPCH pilot channel or reference signal of the first neighbor frequency during the next measurement window 520b. During the next measurement window 520c, the UE performs a search (532) or acquisition on a sync channel for a second neighboring frequency, and during a measurement window 520d after that, performs a measurement (542) on the pilot channel or reference signal of the second neighboring frequency.

The UE continues this alternating pattern of a search procedure and a measurement procedure for each of the other neighboring frequencies included in the cell information list in order (e.g., F3, F4, F5 . . . Fn). For some RATs, the search procedure itself may require multiple steps, with each step possibly needing a separate measurement occasion (e.g., a measurement for a single frequency may require multiple measurement windows 520).

This round-robin process may waste time and resources due to the potential delay in identifying and measuring what may be the most desirable frequency (i.e., the frequency that is best qualified to serve as a possible handover target), such as Fn, or report measurements for the earliest-measured frequencies (e.g., F1, F2, etc.) that are no longer valid. Moreover, this process results in an extended cell reselection procedure, lessening the timeliness of the resulting measurement report (increasing the potential for handover failure), and increasing the chances that the UE will miss page messages broadcast by the serving network.

FIG. 5B discloses an example of a new, improved search and measurement sequence 502 that improves on the conventional sequence 500. When the UE (e.g., UE 110/350) is called upon to perform multiple frequency measurements of neighboring frequencies (either of the same RAT or different RAT), such as F1, F2, F3, . . . Fn, the UE first performs a search/acquisition procedure for multiple frequencies using consecutive multiple measurement occasions. Then, once search results are complete, the UE performs measurement of the acquired frequencies, but ordered based on the search results (such as ordered in terms of signal strength, signal quality, etc.). The UE may use previous search/acquisition results held in a buffer of the UE to order the frequencies for measurement. Thus the UE may measure the strongest signals first, rather than measuring in some arbitrary order as done previously.

As shown in FIG. 5B, during the first measurement window 520a, the UE performs a search/acquisition 531 for the first potential neighboring frequency. During the next measurement window 520b, the UE performs a search/acquisition 532 for the second potential neighboring frequency. If there were additional neighboring frequencies, the UE may continue to search during subsequent measurement windows.

Either during or after searching the neighboring frequencies, the UE (110/350) may sort the order of the neighboring frequencies based on the search results. For example, the neighboring frequencies may be sorted based on the power profiles of the sync channels, the number of sync sequences detected, the number of midambles detected, SINR/SNR, or some combination thereof.

The UE may perform measurements according to this sort order of the neighboring frequencies. For example, in accordance with the sorting criteria, if the second-searched neighboring frequency is quantitatively better than the first-searched neighboring frequency, then as shown in FIG. 5B, the UE performs measurements (542) of the second neighboring frequency in a measurement window 520c, prior to performing measurements (541) of the first neighboring frequency in a subsequent measurement window 520d.

Even without sorting, this process improves the timeliness of the measurements included in the measurement report. This improved outcome is due to the earliest measurements (which in the example in FIG. 5B is of the second frequency) being taken at a time closer to when the UE sends the measurement report to the network. While only two frequencies are illustrated in this example, the benefit of improved timeliness of this strategy (in comparison to the conventional strategy) becomes increasingly consequential with larger numbers of neighboring frequencies to search and measure.

Moreover, while a measurement window 520 may be too short to accommodate both the search and the measurement of a frequency, the search portion takes less time than measurement, such that more than one search may be conducted in a single measurement window. An example of this is illustrated as sequence 504 in FIG. 5C, where the UE performs a search of the first neighboring frequency (531) and the second neighboring frequency (532) in a single measurement window 520a. While this example only shows two searches being performed during a single measurement window 520, more may be performed in a same window, depending upon the amount of time remaining By performing more than one search in a single measurement window, the number of measurement windows required to perform searches on all of the neighboring frequencies included on the cell information list may be significantly reduced.

Based on the improved search-and-measurement framework illustrated by the examples in FIGS. 5B and 5C, several additional optimizations may be added to further improve performance.

Several additional methods may be added to improve performance over the conventional search and measurement sequence 500. Sorting may also be the basis for additional improvements. These include breaking off a search or a measurement if preliminary results for the neighboring frequency render it a poor candidate for handover, culling less promising frequencies from the sorted list of frequencies to be measured, and suspending the search and/or the measurement phases if a search or measurement produces one or more neighboring frequencies that are particularly good.

Breaking off a search if preliminary results for a neighboring frequency indicate it is a poor candidate for handover may have the added benefit of allowing an increased number of searches to be performed in each measurement window. For example, by setting a predefined threshold for the power profile of the sync channel used for gap detection and breaking off searches that do not meet or exceed this threshold, the UE may reduce the approximately 6,400 chips that would be expended conducting a complete search on that frequency space down to 64 chips. With this recovered time, the UE may be able to perform searches of additional frequencies in the same measurement window 520, producing a measurement report even quicker. For example, in the sequence 506 in FIG. 5D, the UE performs searches (531, 532′, 533) on three neighboring frequencies (respectively F1, F2, and F3) during the first measurement window 520a, suspending the search on the second frequency (532′) when preliminary search results for the second neighboring frequency were below the threshold.

A preliminary search threshold may also be set based on, among other things, the number of sync sequences detected. In addition to the time recovered during the search phase, another significant benefit of breaking off a search if the preliminary results do not meet or exceed the threshold(s) is that a measurement will not be performed for the corresponding frequency. For example, in FIG. 5D, no measurement is undertaken for the second frequency. Also, with fewer frequencies to sort based on the search result, a computational benefit may gained (especially if not meeting the threshold(s) results in a large number of candidate frequencies being removed or omitted from the candidate list prior to sorting).

The UE may also break off its measurement activity for particular frequencies are determined during the search phase to have signal quality too poor to be potential handover candidates. Predefined thresholds may be set for one or more aspects of the measurement phase of a candidate frequency, breaking off measurement if results do not satisfy this threshold. If a measurement is cut off early, there may be enough time in the existing measurement window to switch over the next frequency and measure the next frequency on the search list. For example, in FIG. 5D, the sorted search results rank the frequencies in the order F3 and then F1. The measurement for F3 (543′) fails to satisfy a measurement threshold and is suspended. Based on the time remaining in the measurement window 520b, the UE switches over to the next frequency (F1) and performs measurements on F1 (541) in the time remaining in the measurement window.

Depending upon the scope of measurements undertaken by the UE, which may be specified in the frequency measurement request received from the serving Node B with the cell information list, measurements may be divided across more than one measurement window 520. This requires the measurements to be partitioned or partitionable into multiple parts. If the measurements can be subdivided into parts, the dividing them across multiple measurement windows 520 can further optimize the use of the time left unused when a measurement is suspend.

For example, referring to FIG. 5E, the cell information list includes eight potential neighboring frequencies. The UE sequentially performs a search on each of the frequencies in the span of two measurement windows (520a, 520b), completing searches on F1 (531), F3 (533), F4 (534), F6 (536), and F8 (538). However, based on preliminary search results failing to satisfy one or more thresholds, the searches on F2 (532′), F5 (535′), and F7 (537′).

Based on a sorting of the five completed searches, the measurements are ordered F3, F6, F1, F8, and F4. The UE undertakes measurement of F3 (543) in the next measurement window 520c. In the following measurement window 520d, the UE undertakes a measurement of F6, but suspends (546′) the measurement when results fail to satisfy one or more predefined thresholds. Based on there being sufficient time remaining in the measurement window 520d, the UE undertakes measurement of F1. However, F1 also fails to satisfy one or more measurements thresholds, and the measurement (541′) is suspended.

There is insufficient time remaining in the measurement window 520d to undertake a complete measurement on F8. However, as the measurements in this example that are to be sent to the serving Node B are sub-dividable, the UE undertakes a first part of the measurement (548a) in the existing measurement window 520d, switches back to the serving cell for other activities (510), and then returns to F8 in the next measurement window 520e to complete the second part of F8 measurements (548b). In the time remaining, the UE undertakes measurement of all or a portion of F4, but suspends measurement (544′) when preliminary results fail to satisfy one or more predefined thresholds.

As an additional optimization, after the search list is sorted, frequencies may be culled (i.e., discarded) from the list. For example, the UE may undertake measurements for the best “N” neighboring frequencies based on the search/acquisition results, where N is a predefined integer greater than one.

As a further optimization, if the searched for frequencies produce results exceeding predefined thresholds indicating that one or more searches are particularly good, the search phase may be suspended, proceeding directly to sorting and measurement. For example, after the search has produced at least “P” results (results ≧P), where P is an integer equal to or greater than one, and the results include P neighboring frequencies where the detected power profiles, number of sync sequences, and a number of midambles all exceed predefined quality thresholds, then the searching of further frequencies may be suspended. (E.g., if P equals five, and after performing the first eight searches on a search list consisting of 20 frequencies, five frequencies exceed thresholds, then searching may be suspended). If searching is suspended, the UE may either sort all the frequencies already searched up-to-and-including the P particularly good frequencies and then undertake measurements based on the sorted list, or sort and undertake measurements on only the P particularly good frequencies.

Similarly, measurement results may also be stored in a buffer of the UE, and if the measurement of frequencies produces results exceeding predefined thresholds indicating that one or more measured neighboring frequencies are particularly good, the measurement phase may be suspended, sending the measurement report to the serving Node B based on the existing results. For example, after the measurement phase has produced at least “R” results (results ≧R), where R is an integer equal to or greater than one, and the results include R neighboring frequencies where the characteristics measured exceed predefined thresholds, then the measurements of further frequencies remaining on the ordered list may be suspended. (E.g., if R equals three, and after performing the first six measurements from a ordered frequency list consisting of ten searched frequencies, three frequencies exceed thresholds, then measurements may be suspended). The particular predefined thresholds used for this aspect of the measurement phase may depend upon the particular types of measurements specified in the frequency measurement request received from the serving Node B with the cell information list.

When preparing the measurement report for the Node B, the UE includes the results for frequencies where measurements were completed. For the other frequencies, the UE may provide no results if measurements were not completed, provide partial search and/or measurement results where data collection was started but then suspended, and/or provide a predefined default set of poor measurement for partial, suspended, and/or skipped measurements. Because the Node B may use the measurement results in the measurement report to direct the UE to handover to one of the measured frequencies, the predefined defaults may be set to discourage the selection of the corresponding frequencies.

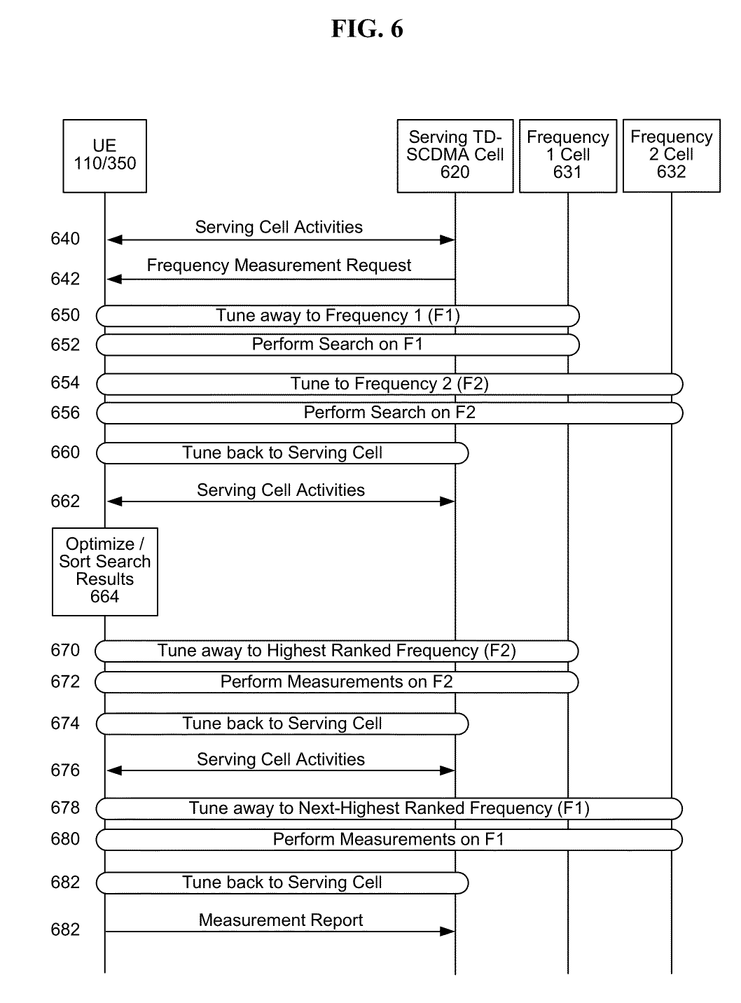

FIG. 6 is an example flow diagram of a frequency measurement request being sent by a serving TD-SCDMA Cell 620 to a UE 110/350, and the UE 110/350 preparing and a measurement report, performing optimized search and measurement as discussed above.

Initially the UE 110/350 is performing communication activities (640, 510) with the serving TD-SCDMA Cell 620. The serving cell 620 sends (642) the UE 110/350 a frequency measurement request, which includes a cell information list identifying multiple potential neighboring frequencies for the UE to measure. The frequency measurement request may also specify what measurements the UE should perform.

At the next available measurement window (e.g., 520a), the UE tunes away (650) from the serving cell 620 and performs a search (652) on the first frequency 631 identified on the cell information list. As there is sufficient time remaining in the measurement window when the first search is completed, the UE tunes away (654) to the second frequency 632 identified on the cell information list, and performs a search (656) on the second frequency. Thereafter, at the end of the measurement window, the UE tunes back (660) to the serving cell and resumes cell activities (662).

At some point, the UE sorts and optimizes (664) the search results. This may be performed after the search phase is completed, or may be performed on an ongoing basis as search results are obtained.

In a subsequent measurement window, the UE undertakes its first measurement based on the sorted list of searched frequencies. In this example, the second search (Frequency F2) produced the best results, so the UE tunes away (670) to F2 and performs measurements (672). With the end of the measurement window, the UE tunes back (674) and resumes communication activities (676). At the next measurement window, the UE tunes away (678) to the next-highest ranked frequency (Frequency F1) in the list sorted based on the search result and performs measurements (680). With the end of the measurement window, the UE again tunes back (682) to the serving cell. As no further frequencies remain to be measured in this example, the UE prepares and transmits (682) the measurement report to the serving cell 620.

The potential neighboring frequencies included in the cell information list may include frequencies associated with more than one RAT. For example, the F1 Cell 631 might support GSM whereas the F2 Cell 632 supports W-CDMA or TD-SCDMA. Also, more than one frequency included in the cell information list may originate from a single cell.

Although the flow diagram in FIG. 6 most closely resembles the sequence 504 in FIG. 5C, it also demonstrates aspects of sequences 502, 506, and 508 in FIGS. 5B, 5C, and 5D, and is readily adapted to include the other optimizations discussed above.

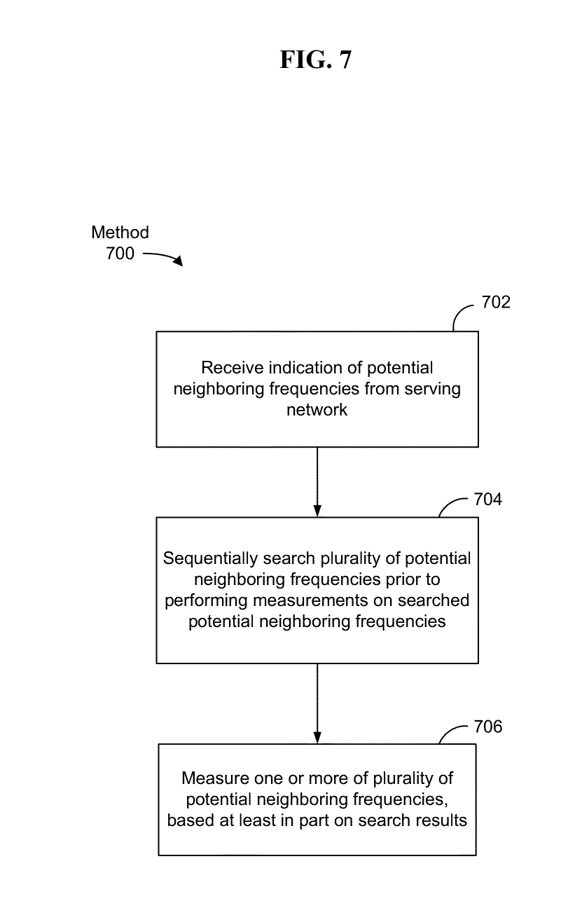

FIG. 7 shows an example of a wireless communication method 700 that may be implemented by the controller/processor 390 of the UE 110/350 to optimize the search and measurement of potential neighboring frequencies. A UE receives an indication of potential neighboring frequencies from a serving network, as shown in block 702. The UE sequentially searches a plurality of the potential neighboring frequencies prior to performing measurements on any of the searched potential neighboring frequencies, as shown in block 704. The UE measures one or more of the plurality of the potential neighboring frequencies, based at least in part on results of the search, as shown in block 706.

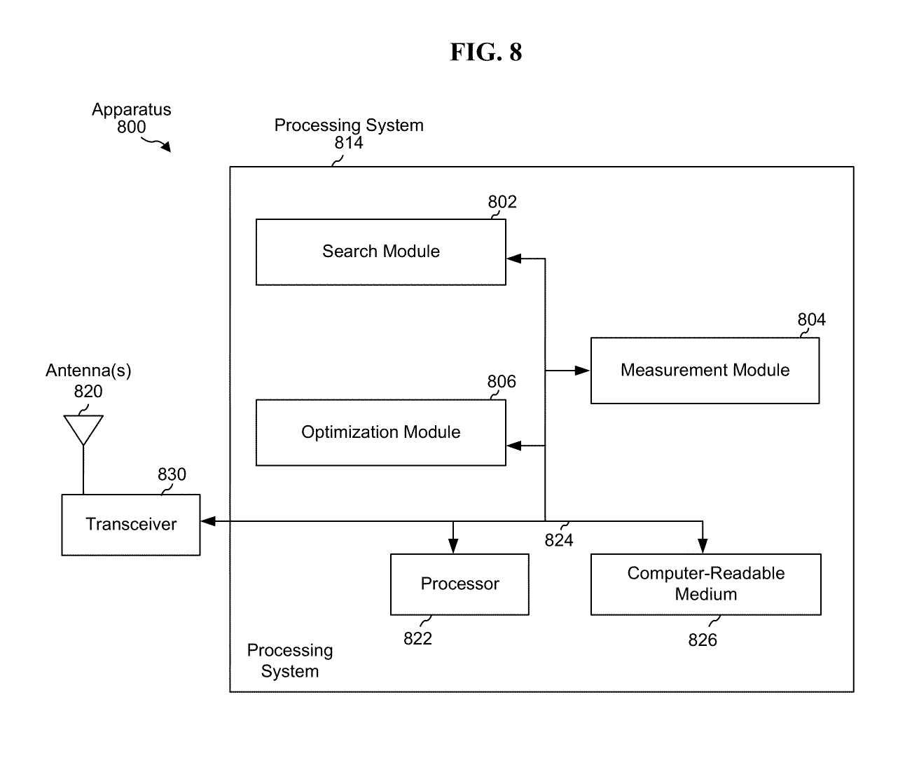

In one configuration, an apparatus such as a UE 110/350 is configured for wireless communication including means for receiving an indication of potential neighboring frequencies from a serving network. The means for receiving may include, for example, the antennas 352/820, the receiver 354, the channel processor 394, the receive frame processor 360, the receive processor 370, the transceiver 830, the controller/processor 390/822, the memory 392, controller/processor executable instructions stored in the non-transitory portion 391 of memory 392 or computer-readable medium 826, and/or the processor 814 configured to receive the cell information list that may be included with a frequency measurement request, as discussed above in connection with FIGS. 5B-5E to 6, and below in connection with FIG. 8.

The UE is also configured to include means for sequentially searching a plurality of the potential neighboring frequencies. The means for searching may include, for example, the antennas 352/820, the receiver 354, the channel processor 394, the receive frame processor 360, the receive processor 370, the transceiver 830, the controller/processor 390/822, the memory 392, controller/processor executable instructions stored in the non-transitory portion 391 of memory 392 or computer-readable medium 826, the processor 814, and/or the search module 802 operating in conjunction with the optimization module 806, configured to sequentially search a plurality of the potential neighboring frequencies received in the cell information list, as discussed above in connection with FIGS. 5B-5E to 6, and below in connection with FIG. 8.

The UE is also configured to include means for measuring one or more of the plurality of the potential neighboring frequencies. The means for measuring may include, for example, the antennas 352/820, the receiver 354, the channel processor 394, the receive frame processor 360, the receive processor 370, the transceiver 830, the controller/processor 390/822, the memory 392, controller/processor executable instructions stored in the non-transitory portion 391 of memory 392 or computer-readable medium 826, the processor 814, and/or the measurement module 804 operating in conjunction with the optimization module 806, configured to measure one or more of the plurality of the potential neighboring frequencies, based at least in part on results of the search, as discussed above in connection with FIGS. 5B-5E to 6, and below in connection with FIG. 8.

The UE may be further configured to include means for discarding one or more of the searched plurality of potential neighboring frequencies. The means for discarding may include, for example, the controller/processor 390/822, the memory 392, controller/processor executable instructions stored in the non-transitory portion 391 of memory 392 or computer-readable medium 826, the processor 814, and/or the optimization module 806, configured to cull/discard one or frequencies, such as when the UE undertakes measurement of the best “N” neighboring frequencies based on results of the search, as discussed above in connection with FIGS. 5B-5E to 6, and below in connection with FIG. 8.

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the search module 802, the measurement module 804, the optimization module 806, and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes several modules. A search module 802 performs the searches on the potential neighboring frequencies on the cell information list, under the control of an optimization module 806. The measurement module 804 performs measurements on the searched neighboring frequencies in accordance with the sorted list, also under the control of the optimization module 806. The optimization module 806 controls the order in which the searches and measurements are performed, sorts the list of searched frequencies, omits frequencies from the list sorted for measurements when a search for individual frequencies is suspended, culls the list if the “N” best optimization is used, and prepares the measurement report (optionally adding the predefined defaults for partial, suspended, and/or skipped measurements). The optimization module 806 also determines whether sufficient time remains to perform an additional search or measurement during a measurement window, and whether to partition a measurement across multiple measurement windows.

In the alternative, the optimization module 806 may instruct the measurement module 804 to perform a measurement, with the measurement module 804 reporting back to the optimization module if insufficient time remains in the measurement window, or partitioning has occurred. Likewise, instead of the optimization module 806 determining whether another search may be performed during a measurement window, the optimization module 806 may instruct the search module 802 to perform a search, with the search module 802 reporting back to the optimization module if insufficient time remains in the measurement window.

The search module 802 determines whether a search should be suspended when preliminary results for a neighboring frequency fail to satisfy one or more predetermined thresholds. Likewise, the measurement module 804 determines whether a measurement should be suspended when preliminary results for measurement fail to satisfy one or more predetermined thresholds.

The optimization module 806 determines whether searches performed by the search module 802 have produced “P” neighboring frequencies that exceed predetermined thresholds, skipping further searches and proceeding directly to the measurement phase. Likewise, the optimization module 806 determiners whether measurements performed by the measurement module 804 have produced “R” neighboring frequencies that exceed predetermined thresholds, skipping further measurements and proceeding to measurement reporting.

The search module 802, the measurement module 804, and the optimization module 806 may be software components running in the processor 822, resident/stored in the computer readable medium 826, one or more hardware modules coupled to the processor 822, or some combination thereof. In addition, the processing system 814 may include a buffer for temporary storage of results from the search module 802 and measurement module 804. The processing system 814 may be a component of the UE 110/350, such that the modules 802-806 may be executed by controller/processor 390 using memory 392, with the code forming the software modules stored in the non-transitory portion 391 of memory 392, and another portion of memory 392 serving as the buffer.

Several aspects of a telecommunications system has been presented with reference to TD-SCDMA and GSM. However, both the serving cell and the cells hosting the neighboring frequencies may be associated with a plurality of different RATs, with some of the cells being of a same RAT. As those skilled in the art will readily appreciate, the disclosed search and measurement optimization strategies may be used in conjunction with fulfilling measurement requests in a geographical area (400) including a variety of different telecommunication systems, network architectures and communication standards. By way of example, the search and measurement optimization strategies may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, some or all of the memory may be internal to the processors (e.g., cache, registers, or non-volatile firmware memory).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for wireless communication, comprising:
receiving an indication of potential neighboring frequencies from a serving network;
sequentially searching a plurality of the potential neighboring frequencies prior to performing measurements on any of the searched potential neighboring frequencies; and
measuring one or more of the plurality of the potential neighboring frequencies, based at least in part on results of the searching.

2. The method of claim 1, in which one or more of the potential neighboring frequencies are of a same radio access technology (RAT) as the serving network from which the indication of potential neighboring frequencies is received, and one or more of the potential neighboring frequencies are of a RAT different than the serving network.

3. The method of claim 1, further comprising discarding one or more of the searched plurality of potential neighboring frequencies, based on results of searching the one or more of the searched plurality of potential neighboring frequencies.

4. The method of claim 3, in which the search and search results include only part of the potential neighboring frequencies received in the indication from the serving network.

5. The method of claim 3, in which the search and search results include all of the potential neighboring frequencies received in the indication from the serving network.

6. The method of claim 1, further comprising sorting an order of the one or more of the plurality of the potential neighboring frequencies for measurement based on results of the searching.

7. The method of claim 1, in which the potential neighboring frequencies sequentially searched include all of the potential neighboring frequencies received in the indication from the serving network.

8. The method of claim 1, further comprising:
cancelling further searching of the plurality of the potential neighboring frequencies in response to detecting a particular potential neighboring frequency having a full or partial search result exceeding predefined thresholds; and
starting to measure the particular potential neighboring frequency immediately.

9. An apparatus for wireless communication, comprising:
means for receiving an indication of potential neighboring frequencies from a serving network;
means for sequentially searching a plurality of the potential neighboring frequencies prior to performing measurements on any of the searched potential neighboring frequencies; and
means for measuring one or more of the plurality of the potential neighboring frequencies, based at least in part on results of the search performed by the means for sequentially searching.

10. The apparatus of claim 9, further comprising means for discarding one or more of the searched plurality of potential neighboring frequencies, based on results of the search performed by the means for sequentially searching, wherein the means for measuring does not measure the discarded one or more of the searched plurality of potential neighboring frequencies.

11. A computer program product for wireless communication in a wireless network, comprising:
a non-transitory computer-readable medium having program code recorded thereon, the program code comprising:
program code to sequentially search a plurality of potential neighboring frequencies received from a serving network, prior to performing measurements on any of the searched potential neighboring frequencies; and
program code to measure one or more of the plurality of the potential neighboring frequencies, based at least in part on results of the searching.

12. The computer program product of claim 11, further comprising:
program code to discard one or more of the searched plurality of potential neighboring frequencies, based on results of the search,
wherein the one or more of the plurality of potential neighboring frequencies to be measured does not include the one or more discarded frequencies.

13. An apparatus for wireless communication, comprising:
a memory; and
at least one processor coupled to the memory and configured:
to receive an indication of potential neighboring frequencies from a serving network;
to sequentially search a plurality of the potential neighboring frequencies prior to performing measurements on any of the searched potential neighboring frequencies; and
to measure one or more of the plurality of the potential neighboring frequencies, based at least in part on results of the sequential search.

14. The apparatus of claim 13, in which one or more of the potential neighboring frequencies are of a same radio access technology (RAT) as the serving network from which the indication of potential neighboring frequencies is received, and one or more of the potential neighboring frequencies are of a RAT different than the serving network.

15. The apparatus of claim 13, in which the at least one processor is further configured to discard one or more of the searched plurality of potential neighboring frequencies, based on results of the sequential search of the one or more potential neighboring frequencies,
wherein the one or more of the plurality of potential neighboring frequencies to be measured does not include the one or more discarded frequencies.

16. The apparatus of claim 15, in which the search and search results include only part of the potential neighboring frequencies received in the indication from the serving network.

17. The apparatus of claim 15, in which the search and search results include all of the potential neighboring frequencies received in the indication from the serving network.

18. The apparatus of claim 13, in which the at least one processor is further configured to sort an order of the one or more of the plurality of the potential neighboring frequencies for measurement based on results of the sequential search.

19. The apparatus of claim 13, in which the potential neighboring frequencies sequentially searched include all of the potential neighboring frequencies received in the indication from the serving network.

20. The apparatus of claim 13, in which the at least one processor is further configured:
to cancel further searching of the plurality of the potential neighboring frequencies in response to detecting a particular potential neighboring frequency having a full or partial search result exceeding predefined thresholds; and
to start to measure the particular potential neighboring frequency immediately.
